(19) United States
(12) Patent Application Publication
(10) Pub. No.: US 2026/0167427 A1
(43) Pub. Date: Jun. 18, 2026

(54) WORKSTATION OF A CONVEYOR

(71) Applicant: EXOTEC PRODUCT FRANCE, CROIX (FR)

(72) Inventors: Dimitri DE TONNAC, LEZENNES (FR); Loïc LEPILLIER, WATTRELOS (FR); Bastien CAGNAC, WASQUEHAL (FR)

(73) Assignee: EXOTEC PRODUCT FRANCE, CROIX (FR)

(21) Appl. No.: 19/417,756

(22) Filed: Dec. 12, 2025

(30) Foreign Application Priority Data
Dec. 13, 2024 (FR) FR2414073

(51) Int. Cl. B65G 1/137

(52) U.S. Cl. CPC B65G 1/1376

(57) ABSTRACT

A workstation of a conveyor for processing orders contained in containers, including a conveyor track configured to route the containers, the conveyor track having a working portion, adjacent to working area Z of an operator, the working portion being configured so that the operator can perform operations on the containers, the conveyor track including a fixed part and a movable part including the working portion, the workstation further having an adjustment mechanism of the conveyor track to adjust a height of the working portion, the height being measured with respect to a reference height of the working area, by moving the movable part with respect to the fixed part.

### TECHNICAL FIELD

The field of the present disclosure is that of Automated Storage and Retrieval Systems (ASRS) and of any other system for transporting articles or goods using conveyors.

### BACKGROUND

When working with goods conveyors, operators are required to perform a number of work tasks on orders contained in containers routed by the conveyors. To this end, one or more workstations may be provided. The term “conveyor” refers to a system or device designed to transport goods, products, or materials from one point to another within a logistics or industrial facility. These systems automate the movement of loads, optimize workflows, and improve operational efficiency by reducing human effort and the time required for transport. The ergonomics of work posts is an important aspect of automated storage systems.

The tasks performed can be strenuous if the position of the operator is not properly adapted. In addition, the routed articles or containers that operators work on can vary in size. This diversity of containers can lead to frequent changes of position.

It is known to position adjustable platforms next to workstations so that the working height of the operator can be adjusted. In fact, rather than standing on the floor or on a fixed structure, the operator can climb onto a platform and lower or raise the height thereof to improve their comfort.

This adjustment can especially be made according to the height of the operator, so that they can achieve a working height that is perfectly adapted to their morphology. However, this consideration is just one example among many situations where a height adjustment may be necessary. For example, certain operators prefer to limit the range of their movements to reduce muscle fatigue, which requires positioning the work area at a specific height. Similarly, poor vision may prompt an operator to move closer to the articles in order to identify them more easily or handle them with greater precision.

In addition, certain tasks involve handling heavy or bulky articles, making it essential to minimize the distance between the arms or hands of the operator and the articles themselves, thereby reducing physical strain and improving ergonomics. The nature of the orders to be processed can also play a decisive role: articles requiring high precision, delicate handling, or increased effort to grasp often call for fine adjustment of the working height. Ultimately, there are a large number of work situations that involve or require adjusting the working height of the operator.

That said, elevated platforms can sometimes present prohibitive disadvantages.

First, their presence necessarily involves a step to access them, which requires operators to climb up and down regularly, thereby increasing the risk of falls. This risk is all the greater given that several operator shifts may take place each day at the same post, increasing the likelihood of incidents.

Furthermore, these platforms require installing bulky and costly structures, which clutter the warehouse and significantly reduce the available space. This reduction impacts not only the circulation of operators and equipment, but also the storage capacity, which is essential for optimizing logistics operations. Furthermore, once on the platform, the operator is confined to a restricted space. To overcome this limitation and cover several work posts or areas, it is necessary to design large platforms, which further exacerbates the problems of cluttering, cost, and adaptation to the warehouse space. In summary, such solutions are far from ideal given the demands of modern logistics environments.

The object of the present disclosure is therefore to at least partially overcome the disadvantages of the prior state of the art cited hereinbefore.

### SUMMARY

The objectives stated hereinbefore are especially achieved by a workstation of a conveyor for processing orders contained in containers, comprising a conveyor track configured to route the containers, the conveyor track comprising a working portion, adjacent to and elevated with respect to a working area Z upon which an operator is positioned, said working portion being configured so that the operator can perform operations on the containers routed by the conveyor track, the conveyor track comprising a fixed part and a movable part, the movable part comprising the working portion, the workstation further comprising an internal adjustment mechanism of the conveyor track configured to adjust a height of the working portion, said height being measured relative to a reference height of the working area of the operator, by moving the movable part of the conveyor track with respect to the fixed part.

In a particularly advantageous manner, the workstation according to the present disclosure has a working portion adjustable in height, typically according to a vertical direction, forming part of the conveyor track. This configuration improves operator ergonomics and efficiency by allowing optimal access to the containers, thus reducing fatigue and increasing productivity. This also allows the working height to be adapted quickly and precisely based on the specific needs of the operator or the features of the containers, thus enhancing the flexibility and adaptability of the workstation. The height adjustment of the working portion makes it possible to accommodate a wide range of variations in operator size.

Such a solution makes it possible, where applicable, to dispense with additional elevation platforms, thereby eliminating the risk of falls associated with such platforms. This also eliminates the clutter and cost associated with these platforms.

In addition, the presence of a movable part integrating the working portion on which the containers are routed allows continuity to be maintained in the conveyor flow during the adjustment of the working height. This allows high-order processing rates to be achieved, thus optimizing the overall efficiency of the conveyor system.

The features disclosed in the following paragraphs can optionally be implemented independently of one another or in combination with one another:

According to one refinement, the conveyor track, including the working portion, comprises a lane configured to allow an automatically guided vehicle supporting a container to travel on said conveyor track.

Such a lane can form a substantially planar surface on which automatic vehicles can travel to route the containers.

In this fashion, the workstation further improves the efficiency and speed of processing orders. In fact, the containers can be routed autonomously to the working portion, where the operator can then focus on the high value-added operations without having to manually handle the containers to take them back to the working area.

According to one refinement, the conveyor track includes a first routing portion and a second routing portion connected to each other by the working portion, the conveyor track being configured to route the containers from the first routing portion up to the second routing portion passing via the working portion.

This arrangement maintains an uninterrupted conveyor flow, even when operations are being carried out on the containers in the working portion. This improves the efficiency of the conveyor system by minimizing interruptions and allowing containers to be handled simultaneously on different portions of the track.

According to one refinement, the first routing portion and the second routing portion extend alongside one another, both on the same side of the working portion.

This configuration allows the workstation to be U-shaped, with the working portion forming one end of the conveyor track. Such a configuration reduces the complexity of the mechanism required to move the movable part of the conveyor track. By simplifying the adjustment mechanism in this way, this arrangement allows for easier and less costly maintenance, as well as reducing the risk of malfunction.

The simplified movement of the movable part makes it more reliable and durable, which contributes to extending the service life of the workstation. Finally, by having both routing portions on the same side of the working portion, the workstation can be integrated more compactly and optimally into the working environment, allowing for better use of the available space and a more efficient organization of workflows.

According to one refinement, the conveyor track presents a general direction V according to which the containers progress, the movable portion of the conveyor track is connected to the fixed part or to the frame in a rotatable manner by a joint presenting an axis of rotation extending transversely to direction V, typically horizontal, the height adjustment of the working portion being performed by the rotation of the movable part with respect to the fixed part about said joint.

By connecting the movable part to the fixed part with a hinge, the workstation can be better integrated into existing conveyor systems, offering a flexible and adaptable solution that can be easily adjusted to the specific needs of the application. This optimizes the order processing procedures and improves the overall efficiency of the conveyor system. In addition, the fact that the joint is positioned transversally to the general direction of progression of the containers, or automated guided vehicles where applicable, makes it possible to adjust the height of the working portion without interrupting the conveyor flow. The containers typically transported by the vehicles can effectively continue to progress along the track even when the track is being adjusted.

According to one refinement, the movable part of the conveyor track extends lengthwise following general direction V from said joint up to a distal end, the working portion being adjacent to said distal end.

In this way, the workstation forms one end of the conveyor track, and the working portion is presented proximate to the working area. The movable portion then forms a lever arm allowing, by means of a simple mechanism, the height of the working portion to be adjusted by rotation about said joint.

According to one refinement, the working portion comprises a working edge at said distal end, the working area Z being located on a first side of the working edge, and the containers being routed onto the working portion on a second side of the working edge opposite the first side.

Furthermore, the distance between the working portion and the axis of the joint can typically be greater than 1 m, or even greater than 1.5 m, or even greater than 2 m, or even greater than 2.5 m, for example 3 m, so as to allow an adjustment displacement of the working portion in the vertical direction of at least plus or minus 100 mm (±100 mm) and with respect to a nominal position of the working portion, corresponding to an angular displacement of the movable part about the joint axis less than or equal to plus or minus 5°, and preferably plus or minus 4°, such as plus or minus 2°.

A vertical adjustment displacement of plus or minus 100 mm covers 95% of the adjustment needs of an adult population.

According to one embodiment, and for a nominal position corresponding to a nominal angle of inclination of the working portion which can be of 9° towards the working area (within ±3°), a variation in the angular displacement of the movable portion about the nominal angle of inclination results in a vertical adjustment displacement of the working portion at least equal to plus or minus 100 mm (±100 mm) about the height of the working portion when in its nominal inclination. For example, the distance between the working portion and the axis of the joint can be 3 meters, and the nominal angle of inclination is 9°. A variation of plus or minus 2° results in an elevation of plus or minus 104 mm.

According to one example, the working portion can extend, away from the working area, or where applicable, away from the working edge, over a distance equal to a maximum dimension of the largest container routed on the working portion. Typically, the working portion extends over a length, away from the working area, of between 30 and 100 cm. According to one example, the distance between the working portion and the axis of the joint can be measured between an orthogonal projection of said axis on a plane formed by the conveyor track and an edge of the working portion.

Such an edge of the working portion could be, according to a first example, a working edge of the working portion, comprising the edge closest to the operator, or according to another example, such an edge could be an edge of the working portion opposite the working edge, corresponding to the edge of the working portion closest to the joint.

According to one refinement, the movable part comprises a first ascending track portion, following the main direction V towards the distal end, and the working portion forms a second track portion, according to an opposite inclination with respect to the first portion, the second portion descending towards the distal end, configured to incline a container routed on the working portion towards the working area.

In this fashion, the working portion has a slope that allows the containers to be inclined towards the operator, thus facilitating access to the containers. The first portion of the track, ascending, allows the containers to be routed at a height above a working height selected by the operator, so that the downward slope required to incline the containers towards the operator brings the working portion back to the selected height.

In addition, the downward slope of the second track portion, which is configured to incline a container routed on the working portion towards the working area, is of downward inclination for all the H height values permitted by the internal adjustment mechanism.

According to one refinement, the adjustment mechanism comprises a toothed component mounted at a distance, according to general direction V, from the joint on one of either the fixed part or the movable part of the conveyor track, and a complementary component mounted on the other of the fixed part or the movable part of the conveyor track, the toothed component comprising a plurality of teeth corresponding to several height values of the working portion of the conveyor track, a tooth of the toothed component being configured to cooperate with the complementary component to manually adjust the working portion to a selected height.

A reliable, simple and cost-effective manual adjustment mechanism is proposed for adjusting the height of the working portion of the movable part.

According to one refinement, the workstation comprises an actuator, with a first end pivotally mounted on the fixed part of the conveyor track and a second end pivotally mounted on the movable part, in such a way that an extension or retraction of the actuator allows the height of the working portion to be adjusted.

This configuration allows the height adjustment process to be fully automated, considerably improving the efficiency and speed of the adjustments. This allows the operator to concentrate on order processing tasks without having to manually adjust the height, thus reducing fatigue and increasing productivity.

According to one refinement, the internal adjustment mechanism comprises two cylinders, each positioned on both sides of a longitudinal median plane according to the feed direction V of the conveyor track.

This ensures a balanced distribution of the forces exerted when adjusting the height of the working portion. This arrangement also stabilizes the movable part of the conveyor track during height adjustments, thus reducing the risk of imbalance and vibration. This improves the precision and reliability of the adjustments, ensuring a stable and secure position for the working portion. The cylinders positioned laterally allow the center of gravity to be maintained therebetween, which improves the overall stability of the structure.

According to one refinement, the workstation comprises a first conveyor track and a second conveyor track, the first routing portion of the first conveyor track extending alongside the first routing portion of the second conveyor track, so that the working portion of the first conveyor track is positioned alongside the working portion of the second conveyor track, the internal adjustment mechanism being configured to adjust the height of each of the working portions of the first and of the second conveyor tracks.

In this way, the workstation allows for simultaneous order picking and preparation by virtue of the integration of two conveyor tracks. The first routing portion of the first conveyor track extends alongside the first routing portion of the second conveyor track, so that the working portions of both tracks are positioned side-by-side and are accessible from the same work post.

According to one refinement, the internal mechanism comprises at least two actuators, with a first actuator connected to the first conveyor track and a second actuator connected to the second conveyor track, so that the heights of the two working portions can be adjusted independently of each other.

In this fashion, the workstation allows independent height adjustment of the two working portions of the two conveyor tracks. This allows containers of different sizes to be handled simultaneously and meets a variety of requirements without compromising the efficiency, productivity, or ergonomics of the post.

According to one refinement, the workstation comprises a human-machine interface connected to a processor and to a memory, the human-machine interface being configured for, in response to a command from the operator, either:
adjusting the height of the working portion to a height value available in the memory, or
increasing or decreasing the height of the working portion to a selected height value.

In this fashion, the operator can adjust the height of the working portion as desired and easily adapt to different work situations.

In addition, the ability to save preset height values in the memory saves time and ensures repeatable and accurate adjustments. This allows the operator to quickly select a predefined height, which improves productivity and reduces the risk of errors.

The present disclosure further relates to an assembly comprising a workstation as described above and at least one automated vehicle for transporting containers configured to route the containers along the conveyor track and at least up to the working portion.

This configuration allows for increased automation of the process of conveying and processing the orders.

The present disclosure also relates to a method of preparing orders implemented by an assembly as previously described, the method comprising a step wherein a container is routed by an automated vehicle to the working portion, and a step of working on the container performed by an operator, for example an operation of collecting an object from the container, or an operation of placing an object in the container.

By routing the containers autonomously to the working portion, the automated vehicle allows operators to be freed from transport tasks, allowing them to concentrate on tasks with higher added value. This reduces fatigue and the risk of injury associated with the manual handling of the containers, thus improving the working conditions and satisfaction of the operators.

According to one refinement, when the workstation comprises a human-machine interface connected to a processor and to a memory, and comprises an actuator with a first end pivotally mounted on the fixed part of the conveyor track and a second end is pivotally mounted on the movable part so that an extension or retraction of the actuator allows the height of the working portion to be adjusted, the method comprises a step of adjusting the height of the working portion wherein the operator sends an instruction via said human-machine interface to the processor which drives the actuator to respond to the instruction of the operator, and, once the working portion has been adjusted according to said instruction, the operator works with the container.

According to one refinement, when the internal adjustment mechanism of the workstation comprises at least two actuators, with a first actuator connected to a first conveyor track, and a second actuator connected to a second conveyor track, so that the heights of the two working portions can be adjusted independently of each other, the method comprises a first step of adjusting the height of the first conveyor track, wherein the processor drives the first actuator, and a second step of adjusting the height of the second conveyor track, wherein the processor drives the second actuator, the height adjustment of the first step being independent of the height adjustment of the second step.

Thus, when, for example, a first type of container of a given size is routed to the first working portion, and another type of container of another given size is routed to the second working portion, it is possible for the operator to independently adjust the height of the two working portions so that each working portion adopts an optimal working height for the operator.

### BRIEF DESCRIPTION OF THE DRAWINGS

Further features, details and advantages will become apparent from the detailed description below, and from an analysis of the appended drawings, wherein:

FIG. 1 is a schematic depiction of a conveyor and a working area on the floor, according to one example,

FIG. 2 is a top view of the conveyor of FIG. 1, showing different sizes of container being routed and an operator standing in the working area, ready to work on the containers,

FIG. 3 is, in views 3A and 3B, two non-exhaustive examples of conveyor tracks,

FIG. 4 is a schematic depiction of a first example of a workstation according to the present disclosure,

FIG. 5 is a schematic depiction viewed from the top of a second example of a workstation according to the present disclosure, wherein the movable part of the conveyor track forms one end of the conveyor track,

FIG. 6 is a schematic depiction viewed from the side of the example of a workstation of FIG. 5,

FIG. 7 is a schematic depiction viewed from the top of a particular example of a workstation comprising two conveyor tracks,

FIG. 8 is a depiction viewed in perspective of a particular example of a workstation,

FIG. 9 is a side view of the example shown in FIG. 8,

FIG. 10 shows a cross-sectional view of a particular example comprising two particularly visible cylinders.

### DETAILED DESCRIPTION

The drawings and the disclosure below contain, for the most part, elements of a definite nature. They can therefore be used not only to improve understanding of the present disclosure, but also to contribute to defining it, where applicable.

In the various figures, the same references designate identical or similar elements. For the sake of brevity, only those elements that are useful for understanding the embodiment disclosed are depicted in the figures and are described in detail below.

In the following disclosure, when reference is made to absolute position qualifiers, such as the terms “front,” “rear,” “top,” “bottom,” “left,” “right,” etc., or relative qualifiers such as “above,” “below,” “upper,” “lower,” etc., or orientation qualifiers such as “horizontal,” “vertical,” etc., reference is made, unless otherwise specified, to the orientation of the figures or of an automatic transport vehicle in its normal position of use. Furthermore, the term “substantially” is to be interpreted as indicating that the result obtained is as precise as the known method used to measure it.

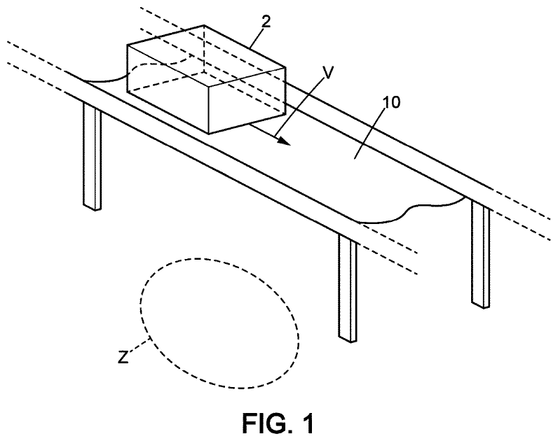

Reference is now made to FIG. 1, which shows a workstation 1 of a conveyor. Such a workstation 1 is especially intended to process orders contained in containers 2, which are routed to the workstation 1.

Such processing can typically include preparing orders, but also the operations of checking, loading, unloading, etc.

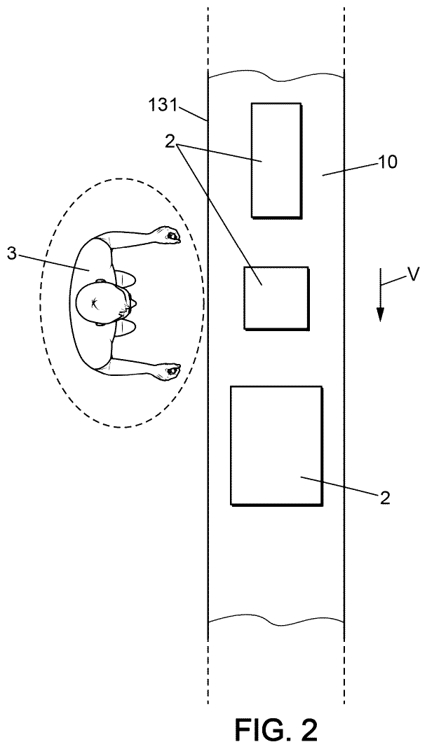

The containers 2 can be of various sizes and weights. As especially shown in FIG. 2, containers 2 of different sizes can be routed to the workstation 1.

The workstation 1 comprises a conveyor track 10 configured for routing the containers 2, typically from another portion of conveyor located upstream of workstation 1.

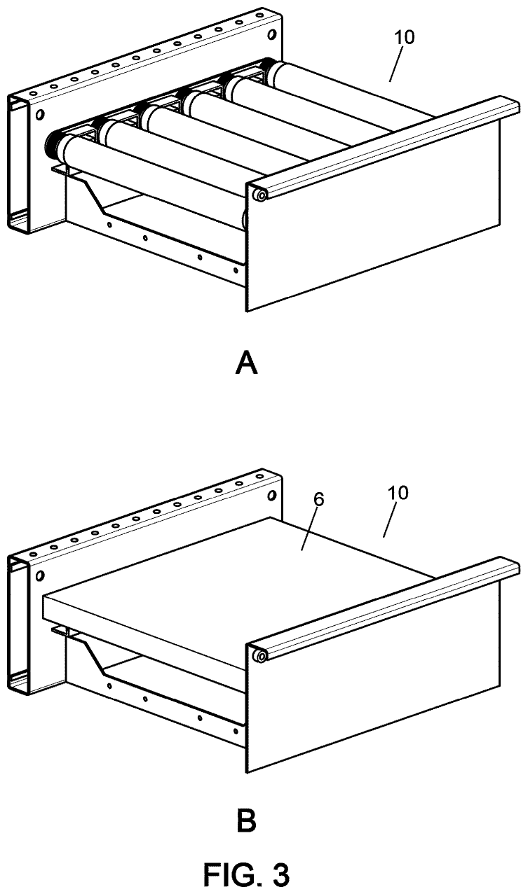

By “configured for routing”, it is understood that the conveyor track 10 can, according to a first example especially illustrated in FIG. 3a, comprise movable members such as rollers to set the containers 2 in motion. According to a known embodiment, at least one of the rollers may be motorized and transmit the rotational torque to the other rollers via transmission belts.

According to another example, especially illustrated in FIG. 3b, the conveyor track 10 comprises a lane 6, forming a substantially planar surface on which the containers 2 can roll. Such solution can especially be adapted for the routing of containers 2 by motorized Automated Guided Vehicles 7 (AGVs).

The workstation 1 is further provided at a working area Z wherein an operator can stand to work at the workstation.

The operator can typically be a human operator, but can also be a robot or robotized installation.

The workstation can be placed on the floor, and the working area Z can be an area on the floor.

In another example (not shown), the working area Z can be an area provided on a platform, distinct from the floor. For example, it can be a platform raised with respect to the floor.

In general, the working area Z, either on the floor or on a platform, allows the operator to stand at a so-called “reference” height H0.

The conveyor track 10 further comprises a working portion 13, adjacent to and positioned at an elevation with respect to working area Z.

Here, “adjacent” means that the working portion 13 can, for example, be defined as a portion of the workstation 1 that includes a working edge 131 proximate to the working area Z of the operator. In this fashion, said working portion 13 is configured so that operator 3 can perform operations on the containers 2 routed by the conveyor track 10 from the working area Z. Typically, the operator may be required to stand on one side of said working edge 131, and perform an operation on a container 2 located on the other side of said working edge 131.

Such working portion 13 is “elevated” with respect to the working area Z, in that it comprises a height H measured in relation to the reference height H0 of the working area Z. Typically, the height H is greater than the height H0, so that the working portion 13 is raised with respect to the working area Z, making the working portion 13 easily accessible to the operator. According to a particular example, the height H of the working portion 13 can vary within an ergonomic height range suitable for the operator.

Typically, the height of the working portion 13 is the height H with respect to the working area Z, the height H is typically measured at the level of said working edge 131. For example, the reference height H0 of the working area Z may be zero, and the height H may be for example between 65 and 110 cm, to optimize the ergonomics of the post. In other cases, if the working area Z is not on the floor, and is located on a platform for example, the reference height H0 could be the height of said platform, and the height H of the working portion 13 could be between 65 and 110 cm in addition to the height H0 of the working area Z.

The workstation 1 may comprise a frame 100, for example fixed to the floor, on which conveyor track 10 is mounted.

The conveyor track 10 further comprises a fixed part 15 and a movable part 14. The fixed part 15 of the conveyor track 10 is a portion of the conveyor track secured to the frame 100. The movable part 14 is then movable with respect to the fixed part 15.

In general, the fixed part 15 of the conveyor track can extend substantially horizontally, at least in the vicinity of the junction with the movable part 14.

The movable part 14 of the workstation 1 further comprises the working portion 13. Thus, the working edge 131 of the working portion 13 is movable with the movable part 14 of the conveyor track 10.

According to the present disclosure, the workstation 1 comprises an internal adjustment mechanism 4 of the conveyor track 10 configured to move the movable part 14 with respect to the fixed part 15, so as to adjust a height of the working portion 13 carried by the movable part 14.

The term “internal mechanism” refers to a mechanism that is an integral part of the workstation 1 and is therefore physically and structurally connected to other elements of said workstation. More specifically, the internal adjustment mechanism 4, as described in this disclosure, is configured to allow for a height guidance of the movable part 14 of the conveyor track 10, which is used to transport the containers 2, and with respect to the fixed part, or even preferably configured to raise the height of the movable part. This configuration ensures that the adjustment of the movable part is performed directly by means of an internal guidance within the workstation, and preferably by means of an internal actuator within the workstation, and thus preferably without the intervention of external height adjustment components for the height actuation. In this fashion, by virtue of the internal adjustment mechanism 4, it is possible to adjust a height H of the working portion 13 with respect to the height H0 of the working area Z of the operator by moving the movable part 14 of the conveyor track 10 with respect to the fixed part 15.

In particular, the working portion 13 is set in motion and moves by a height ΔH to vary its height H. As previously disclosed, the height values are measured with respect to a reference height H0 of the working area Z.

The height variation ΔH permitted by the adjustment mechanism can be positive or negative. In this way, the working portion 13 can be raised or lowered, especially with the aim of improving the ergonomics of the workstation 1.

In general, the conveyor track 10 can present a general direction V according to which the containers 2 progress. Such a general direction V typically corresponds to an elongation direction of the conveyor track.

According to a particular example, the movable portion 14 of the conveyor track 10 is connected to the fixed part 15 or to the frame 100 in a rotatable manner by a joint 5 presenting an axis of rotation extending transversely to direction V. The adjustment of the height H of the working portion 13 being performed by rotation of the movable part 14 with respect to the fixed part 15 about said joint 5.

In other words, the axis of rotation of the joint 5 can be substantially perpendicular to the elongation direction of the conveyor track 10, typically horizontal.

Typically, the movable part 14 comprises a proximal edge, in the vicinity of the fixed part 15, which it is advantageous to maintain at the same height as the fixed part 15, so that the routing of the containers 2 proceeds unhindered. In this way, the joint 5, preferably positioned at this proximal edge, allows the height of the working portion 13 to be varied by rotation.

In particular, the movable part 14 of the conveyor track 10 can extend lengthwise following general direction V from said joint 5 up to a distal end 101, the working portion 13 being adjacent to said distal end 101. A lever arm is thus formed, so that the height of the movable part 14, at the joint 5, remains unchanged, whereas it varies at the working portion 13 located at a distal end 101 of the movable part 14.

As a result, adjusting the height of the working portion 13 leads to a variation in the inclination of the movable part 14: a slope is formed downstream of the joint 5. In order to minimize the variation in inclination, so as to minimize the impact on the routing of the containers 2 passing through the joint 5, the distance L between the working portion 13 and the axis of the joint 5 may be dimensioned to be relatively large. For example, this distance L could be greater than 1 meter, or even greater than 1.5 meters, or even greater than 2 meters.

Especially, such a distance L may be measured between the axis of the joint and an edge of the working portion 13 closest to said axis of the joint 5, such an edge may be defined as being distant from the working edge 131 by a distance equal to the dimension of the largest container being intended to be routed on the working portion 13.

According to another example, such a distance may be measured between the working edge 131 and the axis of the joint.

Advantageously, the variation in inclination Δθ (or otherwise referred to as “angular displacement”) can be between −5° and +5° with respect to the horizontal plane. In other words, it could be advantageous for the distance between the working portion 13 and the axis of the joint 5 to be greater than 1 meter, or even greater than 1.5 mm, or even greater than 2 meters, or even greater than 2.5 meters so as to achieve a height adjustment displacement of the working portion 13 in the vertical direction of at least plus or minus 100 mm (±100 mm) with respect to a nominal position of the working portion, corresponding to an angular displacement of the movable part about the axis of the joint less than or equal to plus or minus 5°, and preferably plus or minus 4°, for example plus or minus 2°, i.e., a limited angular displacement.

According to one embodiment, and for a nominal position of the working portion 13 corresponding to a nominal angle of inclination of the working portion 13 which can be of 9° (within ±3°) towards the working area, a variation in the angular displacement of the movable portion 14 about the nominal angle of inclination results in a vertical adjustment displacement of the working portion at least equal to plus or minus 100 mm (±100 mm) about the height of the working portion 13 when in its nominal inclination.

For example, the distance between the working portion 13 and the axis of the joint 5 can be 3 meters, and the nominal angle of inclination of the working portion 13 is 9°. A variation of plus 2° above the nominal position generates a positive elevation of plus 104 mm, and a negative elevation below the nominal position generates a negative elevation of minus 104 mm.

The variation in inclination Δθ of the movable part 14 is therefore a consequence of the height adjustment of the working portion, which it may be desirable to attenuate.

In particular, the conveyor track 10 of the workstation 1 may comprise a first routing portion 11 and a second routing portion 12 connected to each other by the working portion 13. In this case, the working portion 13 constitutes a segment of a path for the containers 2, between two portions of the conveyor track 10, via which the containers 2 “pass”. The conveyor track 10 is then configured to route containers 2 through the first routing portion 11 up to the second routing portion 12 passing via the working portion 13.

According to certain examples, it may be provided that the automated vehicles and/or the conveyor track 10 be configured to temporarily stop the routing of the containers 2 at the working portion 13, for the time it takes the operator to perform the desired operation.

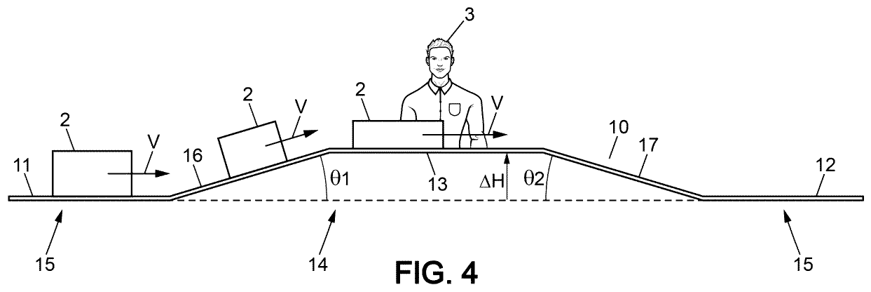

A particular example of a workstation 1 is depicted in FIG. 4.

In this example, the working portion 13 is comprised between a first routing portion 11 and a second routing portion 12.

The containers 2 are routed from the first routing portion 11 up to the second routing portion 12 passing via the working portion 13. Thereby, the containers are routed according to a main direction V.

The internal adjustment mechanism 4 (not shown in this example) may typically include cylinders, one end of which is connected to the fixed frame 100, and another movable end is connected to the movable part 14. The adjustment mechanism 4 is configured to adjust a height H of the working portion 13 by varying it by a height ΔH.

In this example, the displacement in height ΔH of the working portion 13 performs a variation in inclination of the conveyor track 10, especially by creating a first slope 16 of a first inclination θ1, and a second slope 17 of a second inclination θ2 opposite to the first inclination.

According to the example depicted, the first slope 16 is ascending and a second slope 17 is descending. Of course, according to the value of the height variation ΔH, which can also be negative, the first slope 16 can be descending and the second slope 17 can be ascending.

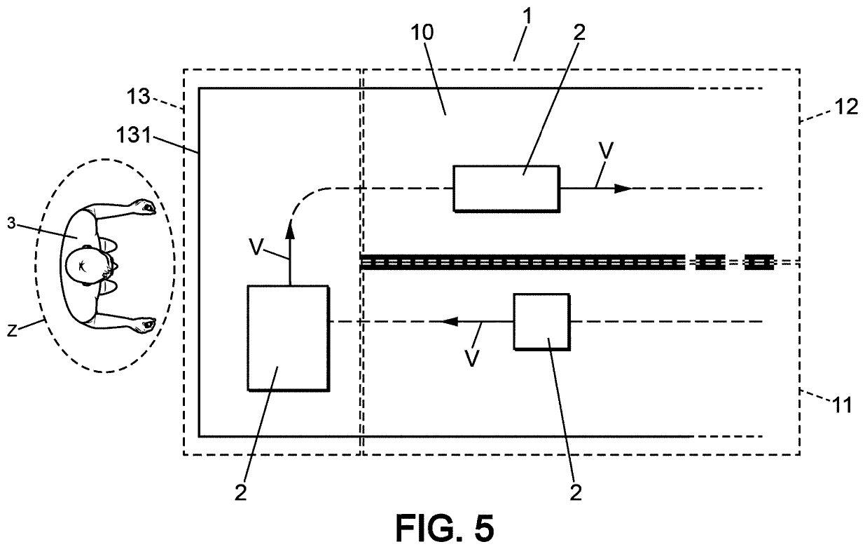

Another example of a workstation 1 is depicted in FIG. 5.

In this example, the first routing portion 11 and the second routing portion 12 extend alongside one another, both on the same side of the working portion 13. In this fashion, the working portion 13 forms one end of the conveyor track 10, so that the containers 2 are routed, prior to the intervention of the operator, in a first direction of travel towards the working portion 13, then in a second direction of travel opposite to the first direction of travel, moving away from the working portion 13 after the intervention of the operator.

According to a particular example, and especially as depicted, the conveyor track can form a “U” shape, with the first routing portion 11 and the second routing portion 12 being distinct from one another.

According to certain examples, the first routing portion 11 can be a portion of the conveyor track via which the containers 2 pass to reach the working portion 13, and the second routing portion 12 can be a portion of the conveyor track 10 via which the containers 2 pass as they leave the working portion 13.

Furthermore, it is possible for the first routing portion 11 and the second routing portion 12 to merge, and for the containers 2 to reach the working portion 13 and leave it via the same path.

In general, the conveyor track 10 presents a general direction V, which defines the direction according to which the containers 2 progress. In the particular example shown in FIG. 5, direction V typically corresponds to the general direction of extension of the conveyor track 10, along which the containers 2 progress to the working portion 13 and according to which they leave it.

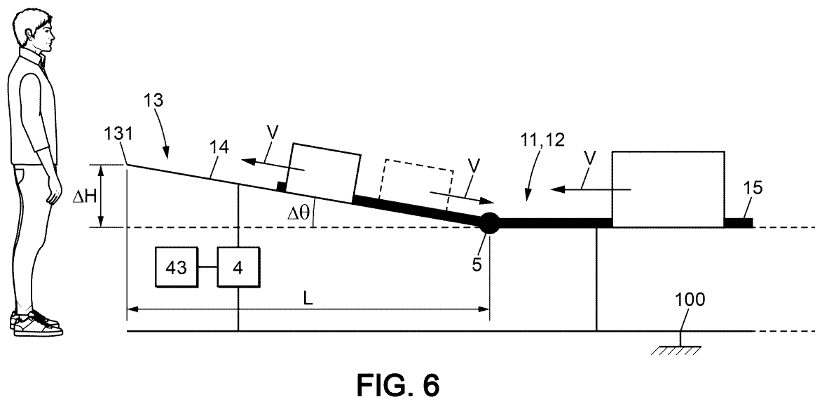

According to a particular example, and especially as depicted in FIG. 6, the movable portion 14 of the conveyor track 10 is rotatably connected to the fixed part 15 by a joint 5 extending transversely to direction V.

In fact, the joint 5 allows the movable part 14 to rotate with respect to the fixed part 15 along an axis that cuts transversely across direction V.

Preferably, the axis of joint 5 is substantially perpendicular to general direction V.

According to this example, the joint 5 is such that an adjustment of the height H of the working portion 13 causes a variation in the inclination Δθ of the feed direction V of the conveyor track 10 at the movable part 14. The change in inclination of the feed direction V can typically take place in a vertical plane, as depicted in the example in FIG. 6.

In this fashion, it is possible to adjust the height of the working portion 13, and thus vary its height by a value ΔH while the containers 2 progress from the fixed part 15 to the movable part 14. The creation of a slope, as a result of a variation in the height of the working portion 13, may in fact make it possible to avoid interrupting the flow of containers 2 during the adjustment.

Such a variation in inclination Δθ of direction V corresponds to a variation in inclination of the movable part 14.

To this end, the workstation 1 can include an actuator 43, configured to vary the height H of the movable part, typically by inclining the movable part 14 with respect to the fixed part 15.

The actuator 43 can for this purpose comprise a first end of 431 pivotally mounted on the fixed part 15 of the conveyor track 10 and a second end 432 pivotally mounted on the movable part 14 of the conveyor track 10, in such a way that an extension or retraction of the actuator allows the height of the working portion 13 to be adjusted.

In particular, “mounted on the fixed part” herein means that the first end 431 of the actuator 43 is mounted on a part secured to the fixed part 15, for example, the frame 100, or even directly on the floor on which the fixed part 15 is mounted.

According to a particular example, the movable part 14 of the conveyor track 10 extends lengthwise following general direction V from said joint 5, and ends with a distal end 101 adjacent to the working portion 13, so that the working area is adjacent to said distal end 101 of the movable part 14.

Typically, said distal end 101 comprises a working edge 131 of the working portion 13. Such a working edge 131 separates the working area Z wherein an operator is located from the working portion 13 to which the containers 2 are routed. In practice, according to one example, the operator stands on a first side of the working edge 131 at the working area Z and reaches the containers 2 on a second side of the working edge 131.

In particular, the movable part 14 of the conveyor track 10 extends lengthwise according to general direction V over a distance L that can be greater than 1 meter, preferably greater than 2 meters.

In fact, it may be advantageous for the said distance L, which separates the distal end 101 from the joint 5, to be relatively large. Depending on the scale of the desired height variation, and for the same height variation ΔH, the variation in inclination Δθ is less significant if the distance L is large. In this fashion, the slope formed by the joint 5 does not hinder the routing of the containers 2.

Typically, the height adjustment of the working portion 13 is such that the variation in height ΔH, measured in relation to the reference height of the working area Z of the operator, is greatest at the working edge 131 of the working portion 13.

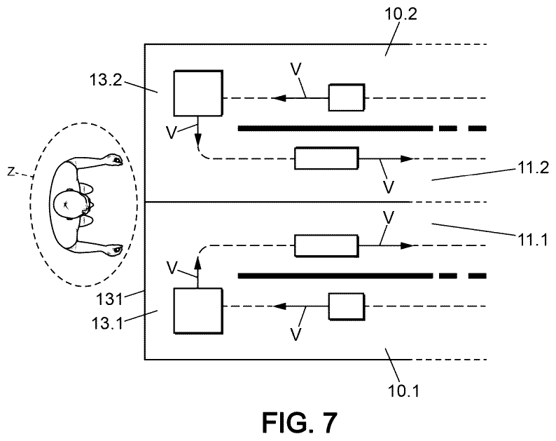

According to a particular example depicted in FIG. 7, the workstation 1 comprises a first conveyor track 10.1 and a second conveyor track 10.2 extending alongside one another, so that a first working portion 13.1 of the first conveyor track 10.1 is positioned next to a second working portion 13.2 of the second conveyor track 11.2.

In this case, the internal adjustment mechanism 4 is configured to adjust the height of each of the working portions 13.1, 13.2 of the first and second conveyor tracks 10.1, 10.2.

Advantageously, it is possible for the adjustment of the first working portion 13.1 and the second working portion 13.2 to be independent of each other. To this end, the internal mechanism 4 can comprise at least two actuators, with a first actuator connected to the first conveyor track 10.1 and a second actuator connected to the second conveyor track 10.2, so that the heights of the two working portions 13.1, 13.2 can be adjusted independently of each other.

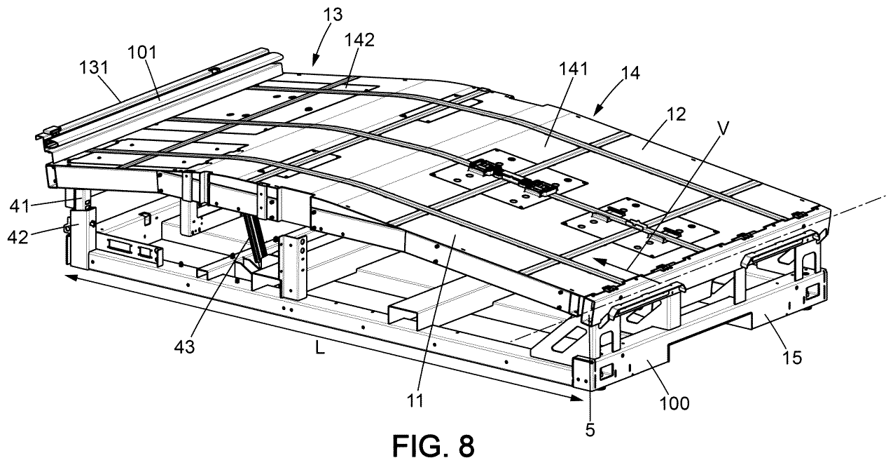

A particular example of a workstation 1, depicted in FIGS. 8 to 10, will now be described.

In these figures, the movable part 14 of the conveyor track 10 is particularly visible, while the fixed part 15 is not depicted. The movable part 14 is movable with respect to the frame 100 on which the fixed part 15 is mounted.

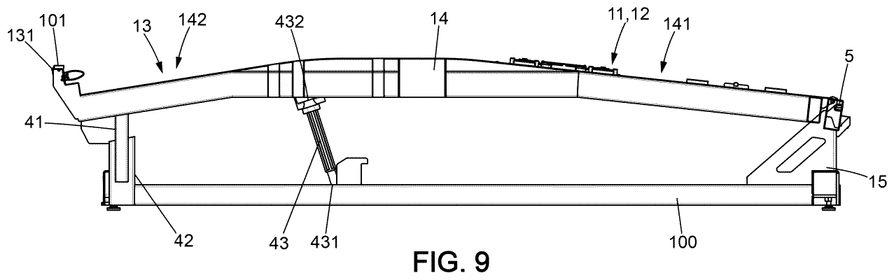

According to this example, and especially with reference to FIG. 9, the movable part 14 comprises a first track portion 141 inclined so that it ascends as the distal end 101 is approached, and the working portion 13 forms a second track portion 142 inclined at an angle opposite to that of the first track portion 141. In fact, the second portion 142 descends toward the distal end 101. In this fashion, the workstation is configured to incline, towards the working area Z, a container 2 routed on the working portion 13.

By “incline towards the working area” it is understood that the working portion 13 comprises a low point located at the working edge 131, in the vicinity of the working area Z of the operator.

In this fashion, if a container 2 is open at the top, a bottom of the container 2 is more easily accessible by virtue of this inclination.

Additionally, according to one example, and in especially as depicted in FIGS. 8 to 10, the adjustment mechanism 4 may comprise means for manually adjusting the height of the working portion 13.

Especially, the workstation 1 can comprise a toothed component 41 mounted at a distance, according to general direction V, from the joint 5 on one of either the fixed part 15 or the movable part 14 of the conveyor track 10, and a complementary component 42 mounted on the other of the fixed part 15 or the movable part 14 of the conveyor track 10, the toothed component 41 comprising a plurality of teeth corresponding to several height values of the working portion 13 of the conveyor track 10, a tooth of the toothed component 41 being configured to cooperate with the complementary component 42 to manually adjust the working portion 13 to a selected height.

In this fashion, it is possible for an operator, using a jack for example, to raise the distal end 101 of the movable part 14 to a desired height, and to engage a tooth of the toothed component 41 with the complementary component 42 to manually adjust the height of the working portion 13 to the desired height.

According to certain examples, the internal adjustment mechanism 4 can further comprise means for automatically adjusting the height of the working portion 13.

In fact, the workstation 1 can comprise an actuator 43, with a first end 431 pivotally mounted on the fixed part 15 of the conveyor track 10, or directly fixed to the frame 100, and with a second end 432 pivotally mounted on the movable part 14, in such a way that an extension or retraction of the actuator allows the height of the working portion 13 to be adjusted.

In fact, the working portion 13 is typically located in the vicinity of the distal end 101 of the movable part 14, so that a rotation at the joint 5 of the movable part 14 with respect to the fixed part 15 generates a variation in height ΔH at the working portion 13.

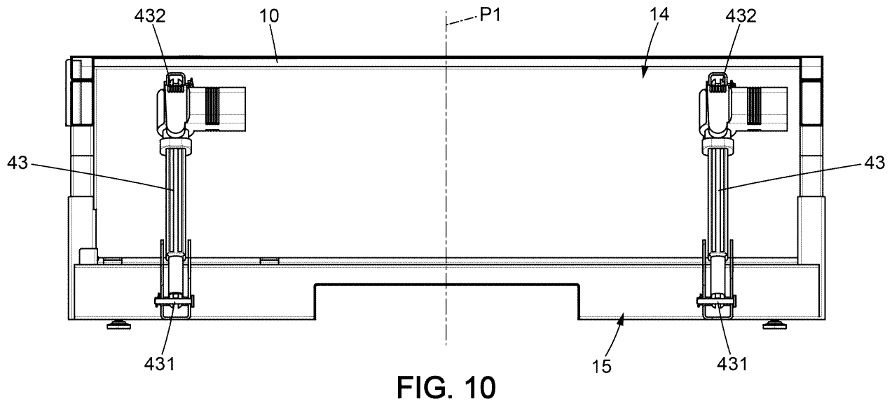

According to a particular example, and especially as depicted in FIG. 10, the internal adjustment mechanism 4 comprises two cylinders, each positioned on both sides of a longitudinal median plane P1 of the conveyor track 10. Preferentially, the two cylinders are positioned at equal distances from said median plane P1, so that the mechanical forces are balanced between the two cylinders.

Additionally, the workstation 1 can comprise a human-machine interface (not shown) typically connected to a processor and to a memory and via which an operator can transmit a command, for either:
adjusting the height of the working portion 13 to a height value available in the memory, or
increasing or decreasing the height of the working portion 13 to a selected height value.

The present disclosure also relates to a method of preparing orders implemented by an assembly comprising the workstation 1 and an automated vehicle 7.

According to one example, the method comprises a step wherein a container 2 is routed by an automated vehicle 7 up to the working portion 13, and a step of working on the container 2 performed by an operator.

Typically, during the working step, the operator is positioned in the working area Z, on a first side of a working edge 131 of the working portion 13, and works on containers 2 routed on the working portion 13 from another side of the working edge 131 opposite the first side.

According to an example wherein the workstation 1 comprises a human-machine interface connected to a processor and to a memory, and an actuator as previously described, the method comprises a step of adjusting the height H of the working portion 13 wherein the operator sends an instruction via said human-machine interface to the processor, which drives the actuator to respond to the instruction of the operator. Thus, if the command of the operator is to increase a height of the working portion 13, or to adopt a prerecorded height value that involves raising the working portion 13, the processor drives the actuator so that it extends and raises the movable part 14 that carries the working portion 13.

The cylinder may include a servo control means configured so that the processor can stop the actuator when the selected height value is reached.

Once the working portion 13 has been adjusted according to said instruction, the operator works on the container 2 during a working step.

According to a particular example wherein the workstation comprises a first and second conveyor track 10.1, 10.2 adjustable independently of each other, the method comprises a first step of adjusting the height of the first conveyor track 10.1, wherein the processor drives the first actuator, and a second step of adjusting the height of the second conveyor track 10.2, wherein the processor drives the second actuator, the height adjustment of the first step being independent of the height adjustment of the second step.

Such an example may be advantageous when a first container 2 of a first height is routed up to the first working portion 13.1, and a second container 2 of a second height is routed up to the second working portion 13.2. In fact, especially for ergonomic reasons, the operator can choose a first height value adapted to the first container 2 for the first conveyor track 10.1, and a second height value adapted to the second container 2 for the second conveyor track 10.2.

In this fashion, the difference in size between the two containers 2 can be advantageously compensated for by independent adjustment of the heights of the two tracks of the working portions 13.1, 13.2.

1. A workstation of a conveyor for processing orders contained in containers, comprising: a conveyor track configured to route the containers, the conveyor track comprising a working portion, adjacent to and elevated with respect to a working area Z upon which an operator is positioned, said working portion being configured so that the operator can perform operations on the containers routed by the conveyor track, the conveyor track comprising a fixed part and a movable part, the movable part comprising the working portion, the workstation further comprising an internal adjustment mechanism of the conveyor track configured to adjust a height of the working portion, said height being measured with respect to a reference height of the working area of the operator, by moving the movable part of the conveyor track with respect to the fixed part.

2. The workstation according to claim 1, wherein the conveyor track, including the working portion, comprises a lane configured to allow an automatic vehicle supporting a container to travel on said conveyor track.

3. The workstation according to claim 1, wherein the conveyor track includes a first routing portion and a second routing portion connected to each other by the working portion, the conveyor track being configured to route the containers from the first routing portion up to the second routing portion passing via the working portion.

4. The workstation according to claim 3, wherein the first routing portion and the second routing portion extend alongside one another, both on the same side of the working portion.

5. The workstation according to claim 1, wherein the conveyor track presents a general direction V according to which the containers progress, the movable portion of the conveyor track is connected to the fixed part in a rotatable manner by a joint presenting an axis of rotation extending transversely to direction V, the height adjustment of the working portion being performed by the rotation of the movable part with respect to the fixed part about said joint.

6. The workstation according to claim 5, wherein the movable part of the conveyor track can extend lengthwise following general direction V from said joint up to a distal end, the working portion being adjacent to said distal end.

7. The workstation according to claim 5, wherein the movable part comprises a first ascending track portion, following the main direction V towards the distal end, and the working portion forms a second track portion, according to an opposite inclination with respect to the first portion, the second portion descending towards the distal end, configured to incline a container routed on the working portion towards the working area Z.

8. The workstation according to claim 5, wherein the adjustment mechanism comprises a toothed component mounted at a distance, according to general direction V, from the joint on one of either the fixed part or the movable part of the conveyor track, and a complementary component mounted on the other of the fixed part or the movable part of the conveyor track, the toothed component comprising a plurality of teeth corresponding to several height values of the working portion of the conveyor track, a tooth of the toothed component being configured to cooperate with the complementary component to manually adjust the working portion to a selected height.

9. The workstation according to claim 1, further comprising: an actuator, with a first end pivotally mounted on the fixed part of the conveyor track and with a second end pivotally mounted on the movable part, in such a way that an extension or retraction of the actuator allows the height of the working portion to be adjusted.

10. The workstation according to claim 9, wherein the internal adjustment mechanism comprises two cylinders, each positioned on both sides of a longitudinal median plane P1 according to the feed direction V of the conveyor track.

11. The workstation according to claim 3, wherein the workstation comprises a first conveyor track and a second conveyor track, the first routing portion of the first conveyor track extending alongside the first routing portion of the second conveyor track, so that the working portion of the first conveyor track is positioned alongside the working portion of the second conveyor track, the internal adjustment mechanism being configured to adjust the height of each of the working portions of the first and of the second conveyor tracks.

12. The workstation according to claim 11, wherein the internal mechanism comprises at least two actuators, with a first actuator connected to the first conveyor track and a second actuator connected to the second conveyor track, so that the heights of the two working portions can be adjusted independently of each other.

13. The workstation according to claim 1, wherein the workstation comprises a human-machine interface connected to a processor and to a memory, the human-machine interface being configured for, in response to a command from the operator, either:
adjusting the height of the working portion to a height value available in the memory, or
increasing or decreasing the height of the working portion to a selected height value.

14. An assembly, comprising: a workstation according to claim 1 and at least one automated container transport vehicle configured to route the containers along the conveyor track and at least up to the working portion.

15. A method for preparing orders implemented by an assembly according to claim 14, the method comprising a step wherein a container is routed by an automated vehicle up to the working portion, and a step of working on the container performed by an operator.

16. The method for preparing orders according claim 15, the workstation comprising a human-machine interface connected to a processor and to a memory, and comprising an actuator with a first end pivotally mounted on the fixed part of the conveyor track and a second end pivotally mounted on the movable part so that an extension or retraction of the actuator allows the height of the working portion to be adjusted, the method comprising a step of adjusting the height of the working portion wherein the operator sends an instruction via said human-machine interface to the processor, which drives the actuator to respond to the instruction of the operator, and, once the working portion has been adjusted according to said instruction, the operator works with the container.

17. The method for preparing orders according to claim 15,, the method comprising: a first step of adjusting the height of the first conveyor track, wherein the processor drives the first actuator, and a second step of adjusting the height of the second conveyor track, wherein the processor drives the second actuator, the height adjustment of the first step being independent of the height adjustment of the second step.
